(19) United States
(12) Patent Application Publication
(10) Pub. No.: US 2014/0140073 A1
(43) Pub. Date: May 22, 2014

(54) LIGHTING UNIT FOR A HOUSEHOLD APPLIANCE

(71) Applicant: Marquardt Mechatronik GmbH, Rietheim-Weilheim (DE)

(72) Inventors: Rainer KIZELE, Tuttlingen (DE); Heinrich MÜLLER, Tuttlingen (DE); Wolfgang MOOSMANN, Wolfach (DE); Björn WERHAN, Blumberg (DE)

(73) Assignee: Marquardt Mechatronik GmbH, Rietheim-Weilheim (DE)

(21) Appl. No.: 14/081,169

(22) Filed: Nov. 15, 2013

Related U.S. Application Data
(63) Continuation of application No. PCT/EP2012/002114, filed on May 16, 2012.

(30) Foreign Application Priority Data
May 19, 2011 (DE) 10 2011 102 078.4

(51) Int. Cl. F21V 33/00; F21V 29/00

(52) U.S. Cl. CPC F21V 33/0044; F21V 29/004
USPC 362/373; 362/382

(57) ABSTRACT

The invention relates to a lighting unit, in particular for a household appliance, for example for the drum of a washing machine, a tumble dryer or the like, comprising a printed circuit board, comprising a light-emitting means arranged on the printed circuit board, and comprising a base for receiving the printed circuit board. The printed circuit board is arranged on a metallic holding part in such a way that good thermally conductive contact is provided between the printed circuit board and the holding part. Furthermore, the holding part is fastened on the base in such a way that, in turn, good heat transfer is provided from the holding part to the base.

### CROSS REFERENCE TO RELATED APPLICATIONS

This application is a continuation of International Application No. PCT/EP2012/002114 filed May 16, 2012, which designated the United States, and claims the benefit under 35 USC §119(a)-(d) of German Application No. 10 2011 102 078.4 filed May 19, 2011, the entireties of which are incorporated herein by reference.

### FIELD OF THE INVENTION

The invention relates to a lighting unit for a household appliance.

### BACKGROUND OF THE INVENTION

Such lighting units are used in particular as LED lighting units in the household appliance sector, for example in washing machines and tumble dryers, dishwashers etc. To be precise, these lighting units are used in particular for lighting the working area in the household appliance, i.e. for example as a drum lighting unit in household appliances.

Such a lighting unit which is suitable for the drum of a washing machine, a tumble dryer or the like has a printed circuit board and a base for receiving the printed circuit board. A light-emitting means is arranged on the printed circuit board. It has been demonstrated that problems associated with the dissipation of the heat generated by the light-emitting means can occur. This in turn impairs the life of the lighting unit.

### SUMMARY OF THE INVENTION

The invention is based on the object of developing the lighting unit such that improved heat dissipation from the light-emitting means is achieved.

In particular, on the basis of the known LED drum lighting unit, the intention is to develop a concept which substantially provides the following advantages:

improvement of the heat dissipation from the LED in order that the LED can be operated at higher current intensities, whereby in turn the luminescence efficacy can be increased;

avoidance of the relatively expensive printed circuit board used to date which has extra thick copper coating; and

maintenance of compact dimensions for the lighting unit.

In the lighting unit according to the invention, the printed circuit board is arranged on a holding part in such a way that good thermally conductive contact is provided between the printed circuit board and the holding part. For its part, the holding part is fastened on the base, to be precise in particular by means of being clamped in on the base, in such a way that good heat transfer is provided from the holding part to the base. Therefore, reliable heat dissipation from the light-emitting means via the holding part and the base to the ambient air and/or to the household appliance per se is ensured, which in turn advantageously extends the life of the light-emitting means.

For the purpose of simple fastening of the printed circuit board, the holding part has a pocket at one end, into which the printed circuit board is plugged for fastening purposes. For this purpose, the pocket can expediently have a hook-shaped configuration. This is a particularly compact arrangement which is suitable for restricted installation conditions for the lighting unit in the household appliance.

In order to save on further component parts, the holding part can at the same time be used for supplying the electrical voltage for the light-emitting means. For this, electrical contact is preferably made with the printed circuit board at the pocket located at the one end. Furthermore, a plug-type connection and/or soldered joint for simple contact-making with the voltage supply, i.e. for connection to the electrical supply voltage, can be integrally formed at the other end of the holding part. Expediently, electrical contact is then made with the printed circuit board and/or the printed circuit board is mechanically fastened by means of two holding parts. For reasons of simplicity, it is an option here for the two holding parts to have a substantially identical configuration.

For protection of the light-emitting means, one option consists in a cover being positioned onto the base. The base and the cover then form a housing for the lighting unit. Expediently, a transparent protective cap can be positioned on the front side facing the printed circuit board for further protection, wherein the size of the protective cap can be matched in a flexible manner corresponding to the installation situation in the household appliance.

Preferably, the light-emitting means consists of an inexpensive and long-life light-emitting diode (LED). For reasons of simple and/or automatable installation, one option consists in soldering the light-emitting diode onto the printed circuit board as an SMD (surface mounted device) component. Furthermore, two contact pads for making electrical contact by means of the holding parts can be provided on the printed circuit board. For reasons of compactness of the lighting unit, the basic area of the printed circuit board is only insubstantially greater than that of the light-emitting means. For this, the printed circuit board has a basic area with a size which substantially corresponds to the sum of the areas of the light-emitting means and the contact pads.

It is an option for the holding part to comprise an elongate bar element. The pocket can be integrally formed at the one end of the bar element and the plug-type connection and/or soldered joint can be integrally formed at the other end of the bar element. The length of the bar element can then be matched in a flexible manner to the length of the base. The size of the base, which ultimately acts as heat sink for the lighting unit, can then in turn be determined in a simple manner corresponding to the respective requirements for the heat dissipation from the lighting unit. For reasons of a simple production process, the holding part can be in the form of a stamped and/or bent element. This results in a concept which can be matched in a very flexible manner for lighting units in different household appliances.

Good illumination of the desired area in the household appliance is often provided by virtue of the printed circuit board being arranged substantially perpendicular to the longitudinal axis of the holding part, in particular therefore perpendicular to the bar element of the holding part. If, however, the installation situation in the household appliance demands it, the printed circuit board can also be arranged at an angle to the longitudinal axis of the holding part, i.e. in particular at an angle to the bar element of the holding part.

Expediently, the holding part consists of metal, which provides good thermal conductivity between the light-emitting means and the base acting as cooling area. In an inexpensive manner, the base and/or the cover and/or the protective cap consists of a polymer. The less favorable thermal conduction of the base consisting of polymer can in this case be compensated for in a simple manner by enlarging the base, in particular in the longitudinal direction thereof. The polymer for the base and/or the cover and/or the protective cap may be a thermoplastic polymer, which makes these parts inexpensive to produce in an injection-molding process.

The following statements refer to a particularly preferred configuration of the invention. An LED lighting unit is provided in which the LED is soldered onto a small standard printed circuit board by means of an SMD process. This printed circuit board has a basic area which is only insubstantially larger than the LED itself and, in addition to the LED soldering surfaces, has only two contact pads, via which contact can be made with the printed circuit board. Contact is made via two simple stamped parts, which each have a pocket at one end, into which pocket the printed circuit board can be plugged and thus contact can be made with the printed circuit board. At the other end, the stamped parts can be shaped to form plug-type connections and/or soldered joints. In order to ensure good heat dissipation, the stamped parts are clamped between the polymer housing parts in such a way that good heat transfer from the stamped part to the housing parts can take place.

The advantages achieved by the invention consist in particular in the following:

good heat dissipation from the LED via the stamped parts and the housing parts is provided. This results in a temperature reduction at the LED of, for example, 20 K in comparison with the previous lighting unit. Owing to the improvement in the cooling effect, the housing can therefore be configured with smaller dimensions and the lighting unit can have a more compact configuration. The use of the lighting unit in household appliances at higher ambient temperatures is therefore also possible. Alternatively, the use of a more inexpensive LED with a lower junction temperature for the lighting unit is also made possible.

Simple matching to various LED types by changing the layout of the printed circuit board is enabled.

Owing to the flexible configuration options of the stamped parts, various emission directions for the heat and/or for the light from the light-emitting means can be realized corresponding to the installation conditions.

A water-tight design of the lighting unit is possible since the heat dissipation takes place by direct contact of the stamped parts with the outer wall of the housing.

The production of the lighting unit is performed by means of inexpensive standard production processes.

The lighting unit has compact external dimensions.

### BRIEF DESCRIPTION OF THE DRAWINGS

Exemplary embodiments of the invention with various developments and configurations are illustrated in the drawings and will be described in more detail below.

FIG. 1 shows a lighting unit in a perspective view;

FIG. 2 shows the lighting unit shown in FIG. 1 in an exploded illustration; and

FIG. 3 shows a lighting unit corresponding to a further embodiment.

### DETAILED DESCRIPTION OF THE INVENTION

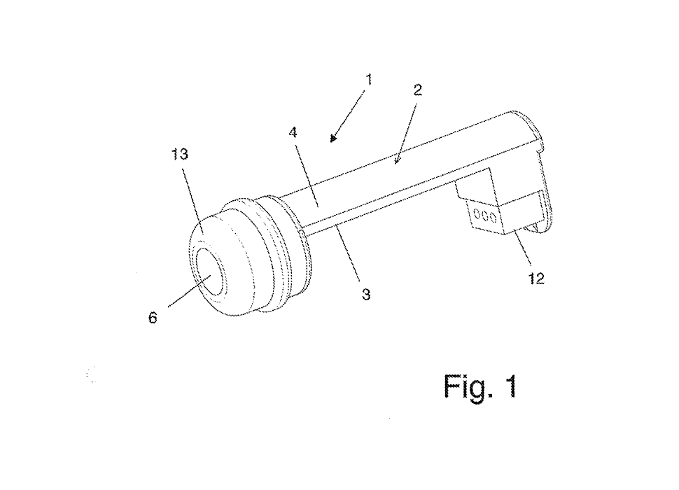

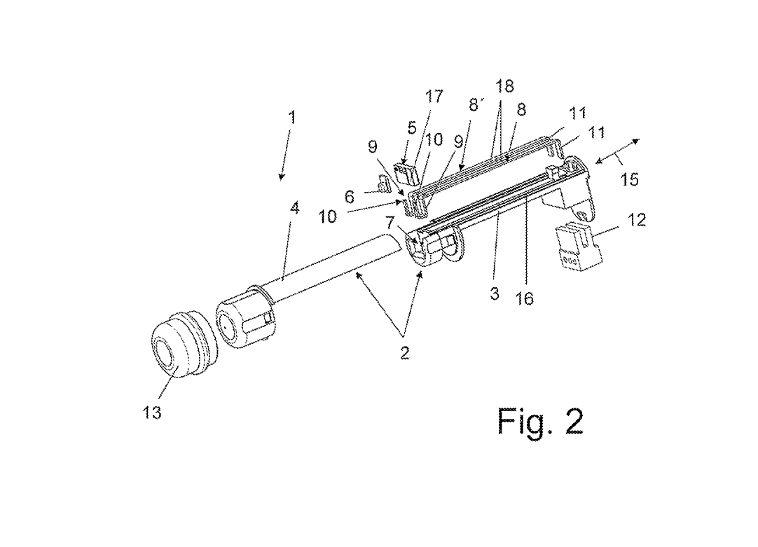

FIG. 1 shows a lighting unit 1 for a household appliance. The lighting unit 1 is used, for example, as a drum lighting unit for the drum of a washing machine, a tumble dryer or the like or as a lighting unit for another working area in a household appliance. The lighting unit 1 has a housing 2, which comprises a base 3 and a cover 4. In this case, the cover 4 is positioned onto the base 3, as can be seen from FIG. 2. As can further be seen from FIG. 2, a printed circuit board 5 is located in the housing 2, wherein a light-emitting means 6 comprising a light-emitting diode (LED) is arranged on the printed circuit board 5. A cutout 7 for receiving the printed circuit board 5 is located in the front side in the base 3. Furthermore, a metallic holding part 8 is located in the housing 2. The printed circuit board 5 is arranged on the metallic holding part 8 in such a way that good thermally conductive contact is provided between the printed circuit board 5 and the holding part 8. Furthermore, the holding part 8 is fastened on the base 3, to be precise by means of the holding part 8 being clamped in in a corresponding receptacle 16 in the base 3, in such a way that good heat transfer is provided from the holding part 8 to the base 3. Thus, the lost heat produced in the light-emitting means 6 can be dissipated in a simple manner via the printed circuit board 5, the holding part 8 and the base 3, acting as cooling area, to the surrounding environment or to the household appliance housing in which the lighting unit 1 is installed. If desired, in addition a heat sink can also be arranged on the base 3 for further improving heat dissipation, but this is not shown in any further detail.

The holding part 8 has a hook-shaped pocket 9 at one end, into which pocket the printed circuit board 5 is plugged for fastening purposes. The holding part 8 at the same time is also used for supplying the electrical voltage for the light-emitting means 6. For this, the holding part 8 has, at the pocket 9, a contact pin 10, which, when the printed circuit board 5 is plugged into the pocket 9, rests on a corresponding contact pad 17 on the printed circuit board 5 for making electrical contact with the light-emitting means 6. A plug-type connection and/or soldered joint 11 for the electrical voltage supply is integrally formed at the other end of the holding part 8. In order to complete the voltage supply, the contact is made with the printed circuit board 5 by means of two holding parts 8, 8′, which have a substantially identical configuration. A plug 12, which is used for connection of the lighting unit 1 to the supply voltage, can be plugged onto the plug-type connections and/or soldered joints 11 on the housing 2. The two holding parts 8, 8′ also effect secure fastening of the printed circuit board 5 in the base 3. The holding part 8, 8′, which comprises an elongate bar element 18, together with the pocket 9 integrally formed at the one end of the bar element 18, the contact pin 10 and the plug-type connection and/or soldered joint 11 integrally formed at the other end of the bar element 18 can be produced as a stamped and/or bent element.

The light-emitting diode 6 can be in the form of an SMD (surface mounted device) component. In this case, the light-emitting diode 6 is soldered onto the printed circuit board 5 using the SMD method. Two contact pads 17 for making electrical contact by means of the holding parts 8, 8′ are provided on the printed circuit board 5, wherein only one contact pad 17 is shown in FIG. 2, however. The printed circuit board 5 then has a basic area with a size which substantially corresponds to the areas of the light-emitting diode 6 and the contact pads 17. As can be seen from FIG. 2, the basic area of the printed circuit board 5 is therefore only insubstantially larger than that of the light-emitting diode 6, which enables a very compact configuration of the lighting unit 1.

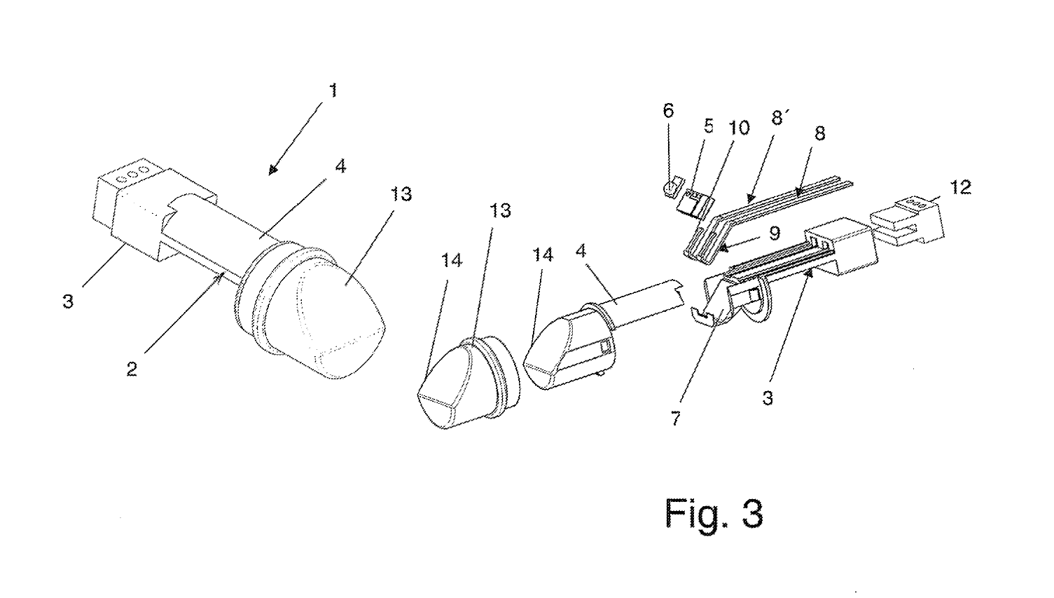

As can be seen from FIG. 2, the printed circuit board 5 is arranged substantially perpendicular to the longitudinal axis of the holding part 8, 8′ or the bar element 18, wherein the longitudinal axis is denoted by the directional arrow 15. In another embodiment which is shown in FIG. 3, the printed circuit board 5 is arranged at an angle to the longitudinal axis of the holding part 8, 8′ or the bar element 18. This configuration can be expedient for particular lighting unit situations in the household appliance. In this case, the cutout 7 in the base is also provided with a corresponding bevel, and the pocket 9 is arranged on the holding part 8, 8′ at an angle to the longitudinal axis 15 of the holding part 8, 8′. In the embodiment shown in FIG. 3, moreover, the plug-type connection is not bent back at the holding part 8, 8′ but runs along the longitudinal axis 15 of the bar element 18. In this case, the plug 12 can then be plugged onto the rear side of the housing 2, while in the embodiment shown in FIG. 2, the plug 12 can be plugged onto the housing 2 from below.

As shown in FIG. 2, a transparent protective cap 13 is positioned on the front side of the housing 2 which faces the printed circuit board 5. In the embodiment shown in FIG. 3, the protective cap 13 and/or the cover 4 are provided with beveling 14 corresponding to the angling of the printed circuit board 5. As already mentioned, the holding part 8, 8′ consists of metal, to be precise of a metal with good electrical conductivity and good thermal conductivity. For example, the metal may be copper, copper-beryllium, bronze, brass or the like. The base 3, the cover 4 and the protective cap 13 consist of a polymer. Preferably, a thermoplastic polymer is used for this, with the result that these parts can be produced by means of injection molding in an inexpensive manner.

The invention is not restricted to the exemplary embodiments described and illustrated. Instead, it also includes all developments by a person skilled in the art in the context of the invention defined by the patent claims. Thus, such a lighting unit 1 can be used not only in household appliances but also in other appliances with a lighting unit.

### LIST OF REFERENCE SYMBOLS

1: Lighting unit
2: Housing
3: Base
4: Cover
5: Printed circuit board
6: Light-emitting means/light-emitting diode
7: Cutout (in base)
8, 8′: Holding part
9: Pocket
10: Contact pin
11: Plug-in connection and/or soldered joint
12: Plug
13: Protective cap
14: Beveling
15: Directional arrow (longitudinal axis of holding part)
16: Receptacle (in base)
17: Contact pad (on printed circuit board)
18: Bar element

1. A lighting unit, in particular for a working area in a household appliance, for example for the drum of a washing machine, a tumble dryer or the like, comprising a printed circuit board comprising a light-emitting means arranged on the printed circuit board, and comprising a base for receiving the printed circuit board, wherein the printed circuit board is arranged on a holding part in such a way that good thermally conductive contact is provided between the printed circuit board and the holding part, and in that the holding part is fastened on the base, in particular by means of being clamped in on the base, in such a way that good heat transfer is provided from the holding part to the base.

2. The lighting unit as claimed in claim 1, wherein the holding part has, at one end, an in particular hook-shaped pocket, into which the printed circuit board is plugged for fastening purposes.

3. The lighting unit as claimed in claim 1, wherein the holding part is used for supplying the electrical voltage for the light-emitting means, in that preferably electrical contact is made with the printed circuit board at the pocket located at the one end, in that further preferably a plug-type connection and/or soldered joint for the connection to the electrical supply voltage is integrally formed at the other end of the holding part, and in that further preferably still electrical contact is made with the printed circuit board and/or said printed circuit board is fastened by means of two, in particular substantially identical holding parts.

4. The lighting unit as claimed in claim 1, wherein a cover is positioned onto the base in such a way that the base and the cover form a housing for the lighting unit, and in that preferably a transparent protective cap is positioned on the front side facing the printed circuit board.

5. The lighting unit as claimed in claim 1, wherein the light-emitting means comprises a light-emitting diode, and in that preferably the light-emitting diode is soldered onto the printed circuit board as an SMD (surface mounted device) component.

6. The lighting unit as claimed in claim 1, wherein two contact pads for making electrical contact by means of the holding parts are provided on the printed circuit board, and in that preferably the printed circuit board has a basic area having a size which substantially corresponds to the sum of the areas of the light-emitting means and the contact pads in such a way that the basic area of the printed circuit board is only insubstantially greater than that of the light-emitting means.

7. The lighting unit as claimed in claim 1, wherein the holding part comprises an elongate bar element, in that preferably the pocket is integrally formed at one end of the bar element and the plug-type connection and/or soldered joint is integrally formed at the other end of the bar element, and in that further preferably the holding part is in the form of a stamped and/or bent element.

8. The lighting unit as claimed in claim 1, wherein the printed circuit board is arranged substantially perpendicular to the longitudinal axis of the holding part, in particular to the bar element.

9. The lighting unit as claimed in claim 1, wherein the printed circuit board is arranged at an angle to the longitudinal axis of the holding part, in particular to the bar element.

10. The lighting unit as claimed in claim 1, wherein the holding part consists of metal, and in that preferably the base and/or the cover and/or the protective cap consist of polymer, in particular a thermoplastic polymer.
